(19) United States
(12) Patent Application Publication
(10) Pub. No.: US 2021/0394213 A1
(43) Pub. Date: Dec. 23, 2021

(54) MULTIFLUID DISPENSING SYSTEM AND METHOD

(71) Applicant: Exojet Technologies, Alba lulia (RO)

(72) Inventor: Claudiu-Paul Corabian, Gherla, Cluj (RO)

(21) Appl. No.: 17/290,132

(22) PCT Filed: Oct. 29, 2019
(86) PCT No.: PCT/EP2019/079574

§ 371 Date: Jul. 1, 2021

(30) Foreign Application Priority Data
Oct. 30, 2018 (RO) A 2018 00856
May 29, 2019 (EP) 19177450.4
Jul. 4, 2019 (EP) 19184531.2

(51) Int. Cl. B05B 11/00; B29C 49/22; B29C 49/42; B65D 1/02

(52) U.S. Cl. CPC B05B 11/0078; B05B 11/3074; B05B 11/3011; B05B 11/3047; B05B 11/3084; B05B 11/3057; B29L 2031/7158; B29C 49/4273; B65D 1/0215; B29B 2911/14573; B29B 2911/1442; B29B 2911/143; B29C 49/22

(57) ABSTRACT

Multifluid dispensing system comprising a receptacle of container in container type and an atomizer Within the receptacle, between at least two of the component-units is provided a connecting-system that includes at least some of: at least one residual interface; at least one permanent-joint of adhesive or weld type; at least one reinforcing functional-form. The connecting-system preferably extends on the entire height of the receptacle. The parts of the connecting-system are preferably, at least partially, superimposed and contained within an operational-section. Additionally, within the receptacle is provided a partitioning-system that consists of at least one mobile-sector which develops via delamination from an internal component-unit. Within the receptacle is equally provided a compression-system that consists of at least one mobile-sector which also develops via delamination from an internal component-unit. The atomizer is made entirely of plastic, is of multifluid type, comprises a return-spring having two curved arms, and a precompression valve-system.

The invention relates to a multilayer container in container type receptacle, particularly to a multi-chamber one, and to a preform-set for making the same. The invention also relates to a method for producing such a receptacle.

The invention additionally relates to an atomizer compatible with multilayer container in container type receptacles, said receptacles being preferably of multi-chamber type.

The invention further relates to a system consisting of a multilayer container in container type receptacle, and an atomizer, both consistent with the present invention.

Multi-chamber receptacles allow storing inside a single receptacle of two or more substances; the dispensing of stored substances may take place either simultaneously, or separately. Multi-chamber receptacles can have varied areas of use, one of the most common being that of cleaning chemicals—household cleaning, but also commercial and/or industrial-type cleaning. Another area of use of such receptacles could be—for instance, but not limited to—the food and drink industry, e.g. carbonated drinks.

In WO2009088285A1 is indicated a way to obtain two storage-compartments within a multilayer container in container type receptacle. The said receptacle consists of three constituent containers/component-units: an external/outermost component-unit, an intermediate component-unit and an internal/innermost component-unit. Following a delamination of its structure, within said receptacle two storage-compartments are obtained: the first one is delimited by the inner surface of the walls of the internal component-unit, whilst the second one is defined by both the exterior surface of the walls of the internal component-unit and the inner surface of the walls of the intermediate component-unit. After completing the liquid-bottling phase, the internal component-unit of the receptacle—and the liquid therein—ends up being for the most part submerged in the liquid held by the intermediate component-unit. The two storage-compartments of said receptacle are therefore not independent, individual. As an effect, it may be difficult to adequately manage the usage of the two liquids inside.

It is an object of present invention to deliver a multi-chamber multilayer container in container type receptacle equipped with individual, independent, possibly symmetrical storage-compartments allowing airless liquid-storing and 360 degrees operation of a dispensing system or device of which said receptacle may be a part. It is equally an object of the present invention to provide at least a method for producing such a receptacle. It is additionally an object of the present invention to provide an atomizer, preferably of multifluid type, compatible with the previously indicated receptacle, and which said atomizer may also be entirely made of plastic and with a small number of components. It is further an objective of the present invention to deliver a dispensing system comprising a multi-chamber multilayer container in container type receptacle, and a suitable atomizer, preferably of multifluid type. The present invention may accomplish additional objectives as well.

According to the main embodiment of the invention, a container with two internal storing compartments can be obtained by (i) initially blow-molding a set of three preforms into a laminated three-layer container, and (ii) subsequently morphing, transforming, the inner-most layer, or component-unit, of the resulting three-layer container into a partitioning system, or divider.

The aforementioned morphing process is done, preferably in a controlled manner, by (1) firstly delaminating, or peeling off, at least one section of the surface area of said inner-most component-unit from the rest of the structure of said container, and then (2) repositioning said delaminated section in a new location, e.g., on the longitudinal median of said container, so that it ends up dividing the internal volume of said container into at least two separate storing compartments or chambers. The resulting compartments formed on either side of the partitioning system can be either symmetrical, possibly having the same internal volume, or asymmetrical, with volumes of different values, or even a combination of the previous two.

In order for said partitioning system to be effective, its boundaries or margins should remain firmly connected on most of its periphery to the rest of the structure of said container.

Therefore, a corresponding connecting system that firmly joins the partitioning system to said container is needed.

The connecting system of the present invention is of hybrid type, consisting of at least two, preferably superimposed, components: (i) at least one permanent joint, and (ii) at least one segment of a residual interface.

The permanent-joint is a non-breakable line or stripe, of adhesive or weld type, executed between the components of the precursor set of preforms of the three-layer container, preferably on what will eventually be the longitudinal median of the resulting said container. At the end of the blow molding process, the permanent joint emerges as a permanent bond between the layers of said container.

It is highly unlikely though that during the blow molding process the permanent joint will accurately keep its original position, namely on the longitudinal median of the resulting three-layer container. Most likely the permanent joint will end up having a rather twisting or winding profile.

However, the irregular final shape of the permanent joint may very well prove irrelevant for the general design and operation of said multi-chamber container since its geometry is covered, or concealed, by the second element of the connecting system, the residual interface, which is briefly described below.

When configuring the partitioning system, not all the surface area of the inner-most component-unit of said container is required to form the walls of said partitioning-system. Therefore, those sectors of the inner-most component-unit not involved in that process will not be delaminated, but instead will form part of the connecting-system. Hence, residual interfaces represent adhesive contact surfaces between those said non-delaminated sectors of the inner-most layer and the rest of the structure of said container. The permanent joint and residual interfaces are superimposed elements, with the latter covering, concealing, the former by means of its much larger area.

During the internal configuration of said receptacle, in order to allow for the repositioning of the sections which make up said partitioning system, some other sectors of the same surface area of the inner-most component-unit will end up being eventually pleated, or folded. These are sectors placed between the sections forming the partitioning system and those forming said residual interfaces, and in the end they will be folded over the residual interfaces, in the immediate vicinity of the partitioning-system.

This internal configuration of the receptacle, consisting of the aforementioned delamination and repositioning processes, could also be carried out in the liquid-bottling stage of the receptacle, even utilizing liquids that are actually being bottled.

To enable airless liquid-storing and 360 degrees operation of a dispensing system comprising such a receptacle, a decrease in the volume capacity of the storage-compartments therein should occur during the cycle-of-use of said receptacle in step with liquid-utilization therefrom, preferably by means of an additional compression-system. The said compression-system should first develop from the walls of one of the internal component-units via a delamination process. Then, by gradually repositioning said walls during the cycle-of-use of the receptacle, a progressive decrease in the volume capacity of the storage-compartments can be obtained.

SUMMARY DESCRIPTION OF THE FIGURES

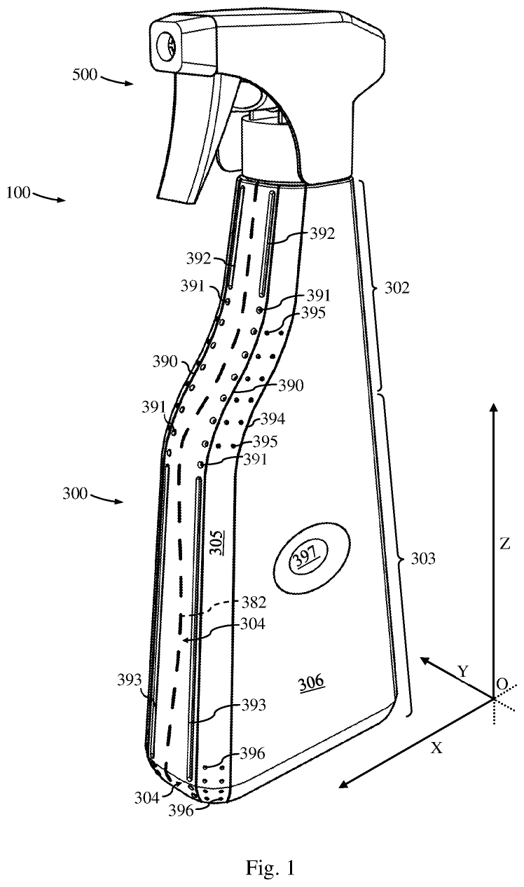

FIG. 1 perspective view of a dispensing system comprising a CIC-type receptacle and an atomizer

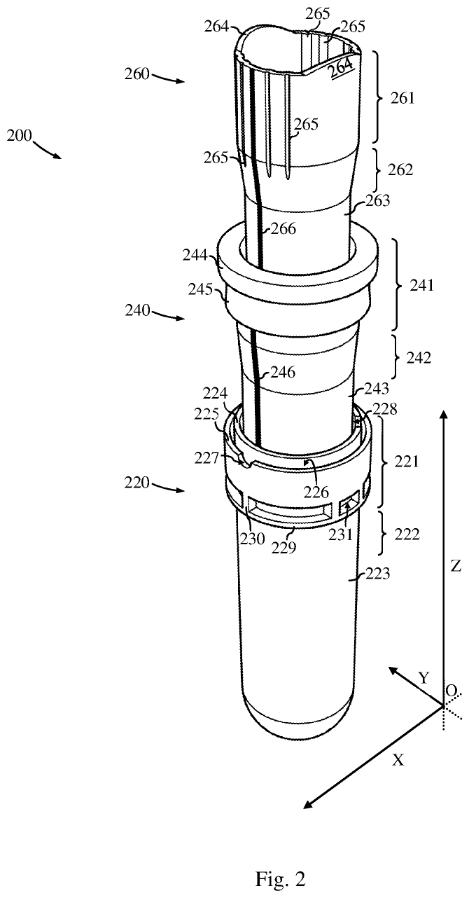

FIG. 2 exploded view of a preform-set

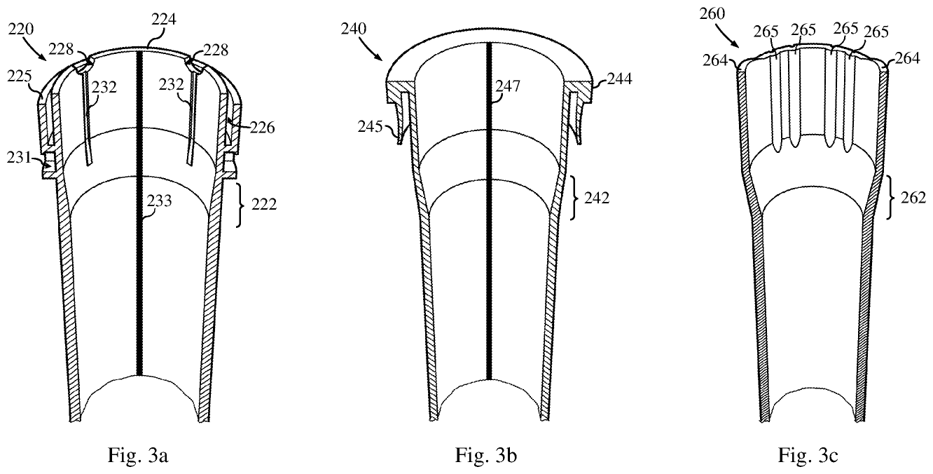

FIG. 3a-3c cross sectional perspective view of the component-preforms of a preform-set

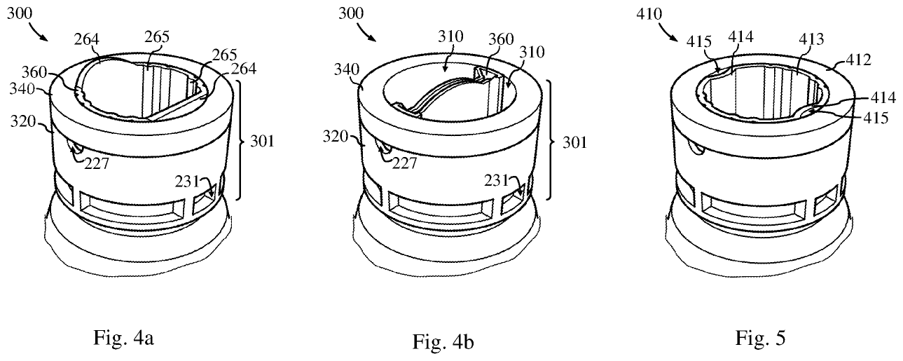

FIG. 4a-4b perspective view of the upper-segment of a CIC-type receptacle

FIG. 5 perspective view of the upper-segment of an alternative CIC-type receptacle

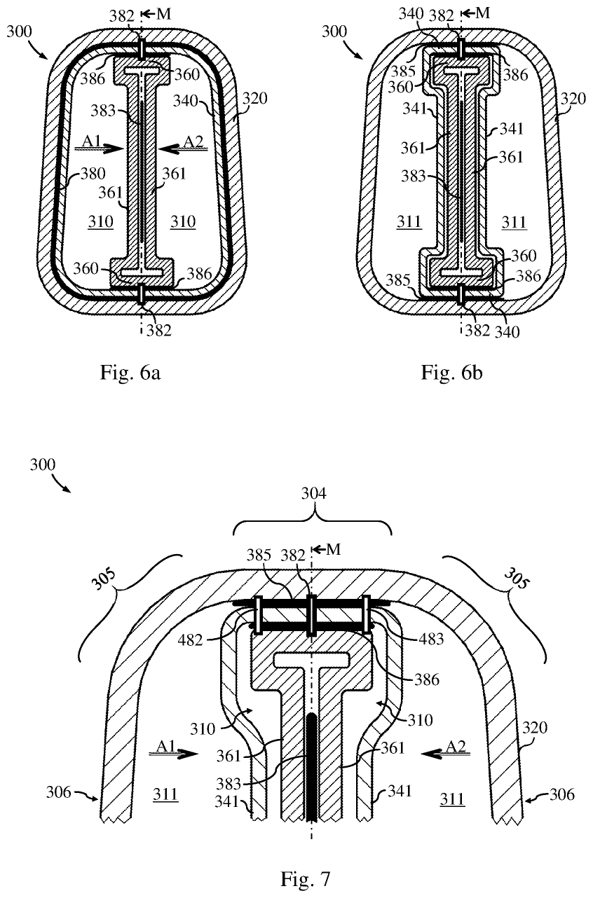

FIG. 6a-6b schematically, a CIC-type receptacle in horizontal sectional views

FIG. 7 schematically, a CIC-type receptacle in a horizontal sectional view

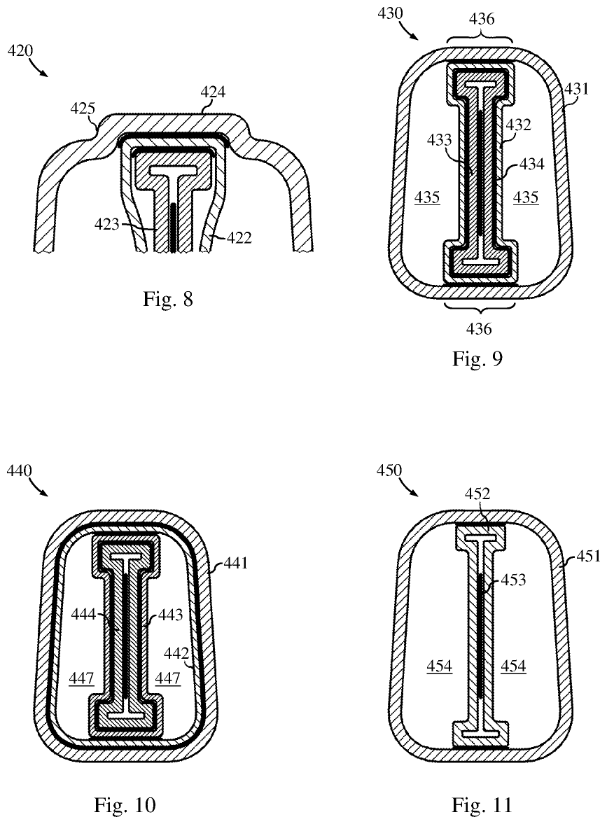

FIG. 8-11 schematically, alternative CIC-type receptacles in horizontal sectional views

FIG. 12 exploded view of an atomizer

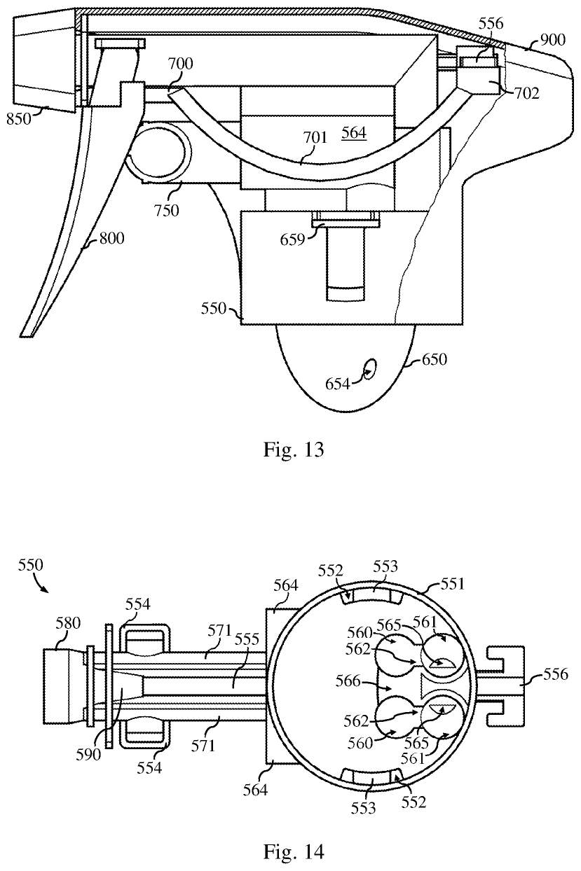

FIG. 13 side view of an assembled atomizer

FIG. 14 bottom view of the main body of an atomizer

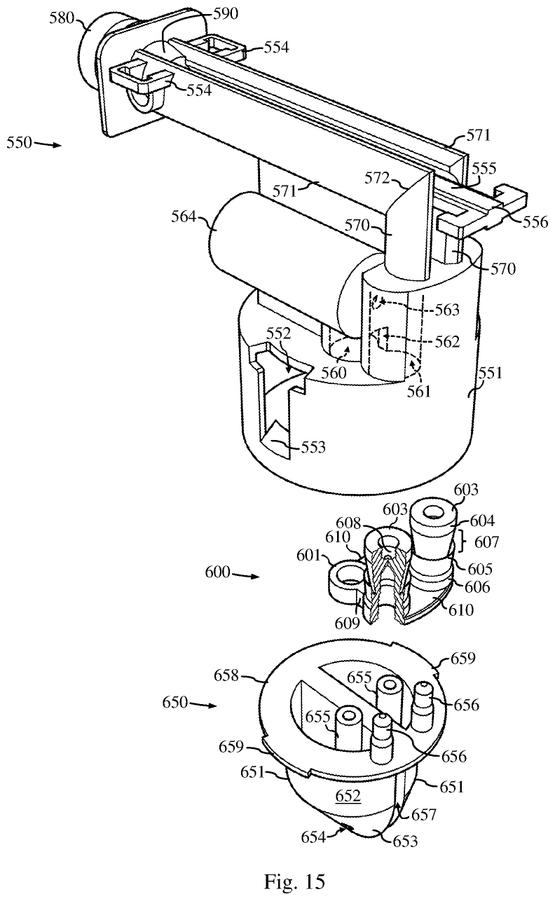

FIG. 15 perspective view of some components of an atomizer

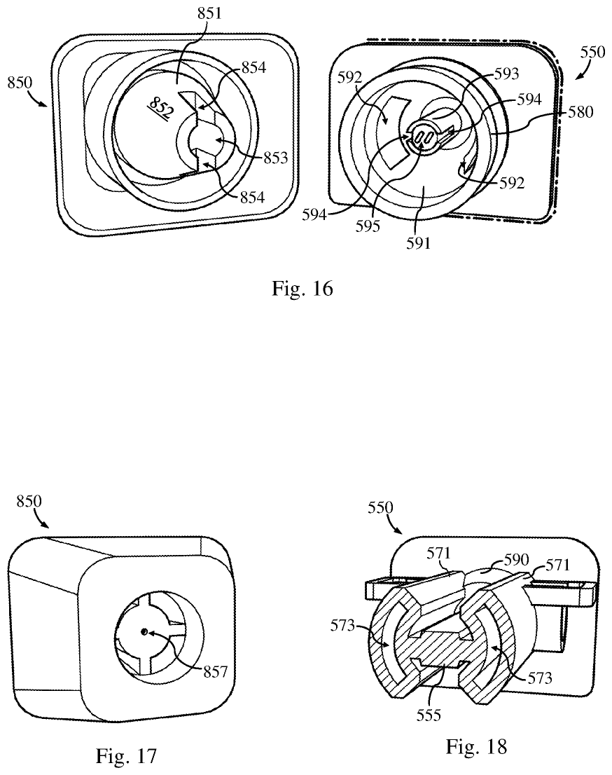

FIG. 16 perspective view of certain components of an atomizer, i.e. the spraying nozzle and the forepart region of the main body

FIG. 17 perspective view of the spraying nozzle of an atomizer

FIG. 18 cross sectional perspective view of the forepart region of the main body of an atomizer

In the description, a container in container type receptacle made according to this invention—essentially a multilayer/composite/laminate container, possibly a multi-chamber one—is predominantly called a CIC-type receptacle. The term CIC-type receptacle is used for such receptacles without regard to their configuration phase, i.e. both before and after the compartmentation.

In the description, a multi-chamber receptacle means a receptacle having more than one storage-compartment.

In the accompanying drawings, X represents the longitudinal axis, Y the lateral axis, and Z the vertical axis. In the description and illustrations (e.g. FIG. 6a-6b), M indicates the median (the middle) of a CIC-type receptacle, or a preform-set, or an atomizer, or a dispensing system, in relation to the longitudinal axis X. In the description, unless explicitly stated otherwise, lateral (parts, sides, areas etc.) signifies parts, components, areas, regions, sides etc. located on one side or the other of the median M.

Relative to the substances that could be stored in and dispensed from a CIC-type receptacle, the description refers in particular to liquids. However, the invention also applies to other types of substances with reduced molecular cohesion (other types of fluids, viscous substances etc.).

According to the invention, “cycle-of-use” means the period between starting using a CIC-type receptacle, or a system, or a device of which said receptacle may be a part, and the fluid-exhaustion of said CIC-type receptacle.

According to the invention, the term operation(s) with its derivatives operating, operate etc., may be used in relation to certain processes—such as, but not limited to, the repositioning or moving of certain parts, surfaces or components of a CIC-type receptacle—both during the “cycle-of-use”, but also prior to that stage (e.g. while configuring the storage-compartments etc.).

In the description, transforming a preform or preform-set into a receptacle—a process that requires at least reheating, stretching and then the blowing—is called blow-molding.

### CIC-type Receptacle Details

FIG. 1 illustrates a perspective view of a dispensing system 100 comprising a CIC-type receptacle 300 and an atomizer 500.

According to the main embodiment of the invention, a CIC-type receptacle 300 is composed of three constituent containers—an external one and two internal ones—hereafter called component-units: one external component-unit (the outermost one), one intermediate component-unit (the middle one) and one internal component-unit (the innermost one). Said three component-units form together a multilayer/composite/laminate structure. A CIC-type receptacle 300 is obtained from a preform-set 200 (FIG. 2), following a blow-molding process.

The following section details a preform-set.

According to the main embodiment of the invention, a preform-set 200 comprises one external and two internal component-preforms, assembled together: the external component-preform 220, the intermediate component-preform 240, and the internal component-preform 260, FIG. 2, FIG. 3a-3c.

In the geometry of the component-preforms 220, 240 and 260 are present a series of vertical segments with specific roles. The upper-segments 221, 241 and 261 could incorporate—from the production phase of their respective component-preforms, i.e. 220, 240, and 260—a number of functional elements required at least in one of the following stages related to a CIC-type receptacle 300: blow-molding, compartmentation and/or liquid-bottling, and, furthermore, the assembly and use of a dispensing system 100. Examples of such functional elements are flange 229 and stiffening members 230, as well as grooves 265, FIG. 2. Other functional elements present at the level of the upper-segments 221, 241 and 261 will be identified as the description progresses.

The corresponding upper-segments 221, 241, and 261 of the component-preforms 220, 240 and 260 are non-transformable during the blow-molding process. As a result, after assembling the preform-set 200 (not illustrated fully assembled), the geometry of the top end of said preform-set 200—the part incorporating the upper-segments 221, 241, and 261—should be identical to that of the upper-segment 301 of a CIC-type receptacle 300 (FIG. 4a).

The corresponding intermediate-segments 222, 242 and 262 of the component-preforms 220, 240 and 260 may be fashioned as transitional segments that tolerate certain shape transformations during the blow-molding process; functional elements possibly integrated into the structure of these segments may therefore also suffer shape transformations.

The corresponding lower-segments 223, 243 and 263 of the component-preforms 220, 240 and 260 should allow extensive shape transformations during the blow-molding process.

The component-preforms 220, 240 and 260 can be manufactured individually by injection molding or by means of alternative methods—for example, but not limited to, 3D printing. The component-preforms—all or only some of them—may also be produced as a unitary structure obtained, for example but not exclusively, via a sandwich-type injection.

The geometry of the component-preforms 220, 240 and 260 may differ from the circular shape illustrated in the drawings related to the description of the invention.

General geometry may differ from one component-preform—i.e. 220, 240 and 260—to another.

A permanent-joint could also be carried out within a preform-set as part of a future connecting-system that could be necessary later in order to assist the operation of the resulting CIC-type receptacle. The permanent-joint could be executed, preferably but not mandatory, on the longitudinal median M vertically or substantially vertically, and it could extend preferably on the entire height of the preform-set (e.g. the main embodiment), or only partly (e.g. certain alternative embodiments specified later which only need a partial connecting-system). The permanent-joint can be provided between at least two of the component-preforms, as at least one non-breakable line or stripe of adhesive or weld type.

If executing the permanent-joint with adhesive, the lines or stripes of adhesive may be located within the preform-set 200 as follows (FIG. 2, FIG. 3a-3b): 233, on the inside of the external component-preform 220; 246 and 247, on the outside and respectively on the inside of the intermediate component-preform 240; 266, on the outside of the internal component-preform 260. In practice it is not necessary to execute all said lines or stripes, but as stated above, at least one should be present.

Instead of executing the permanent-joint 382 with adhesive—or possibly in addition to using adhesive—within the preform-set 200 a permanent-joint can also be achieved by means of welding (not illustrated). The permanent-joint by welding can be executed either after completion of a partial assembly or after the main assembly of the preform-set 200. Welding can be performed, for instance, by ultrasound, laser or other methods.

In the main embodiment of the invention, a permanent-joint carried out in the production phase of the preform-set 200 will later emerge in the structure of a CIC-type receptacle 300 as permanent-joint 382 (FIG. 1), preferably on the entire height of said receptacle.

The preform-set 200 is transformed into a CIC-type receptacle 300 (FIG. 1) via a blow-molding process. The component-preforms of the preform-set 200 (i.e. external component-preform 220, intermediate component-preform 240 and internal component-preform 260) thus become the corresponding component-units of said receptacle (i.e. external component-unit 320, intermediate component-unit 340 and internal component-unit 360). FIG. 4a-4b illustrate the upper-segment 301 of the CIC-type receptacle 300, practically the neck area of said receptacle and the opening at the top of it.

According to the main embodiment of the invention, two storage-compartments can be obtained within a CIC-type receptacle 300 by transforming certain lateral areas of the walls of the internal component-unit 360 into a partitioning-system. The said partitioning-system can develop via: (i) a delamination process carried out in the area of at least one side-section 306 and possibly also of a slanted-section 305, by separating the walls of the internal component-unit 360 from the walls of the intermediate component-unit 340; and simultaneously, or subsequently (ii) running a repositioning process of those separated walls of the internal component-unit 360 preferably towards the median M following directions A1 and A2 (FIG. 6a).

A partitioning-system can thus be formed—preferably a double-walled one, e.g. partitioning-system 361.

Concurrently with the formation of the partitioning-system 361, two storage-compartments 310 also emerge in the lateral areas of the CIC-type receptacle 300, between the walls of the partitioning-system 361 and the exterior lateral walls of said receptacle.

The configuration of a CIC-type receptacle 300, a phase that includes both processes indicated above, i.e. the delamination and the repositioning of those certain lateral areas of the walls of the internal component-unit 360, may be carried out during the liquid-bottling stage of a CIC-type receptacle 300, even utilizing the liquids being bottled.

Inside the two storage-compartments 310, liquid-storing should preferably be airless, so without contact between stored substances and the atmospheric air. Also, a dispensing system of which a CIC-type receptacle 300 may be a part—e.g. the dispensing system 100—should preferably also be able to operate at 360 degrees without utilizing specialized additional components. To fulfill both the above criteria, the volume capacity of each storage-compartment 310 therein should preferably be able to gradually decrease during the cycle-of-use, in step with the liquid-utilization therefrom.

The said decrease in the volume capacity of the storage-compartments 310 can be accomplished by using a compression-system formed from certain lateral areas of the walls of the intermediate component-unit 340 and which said walls partake in delimiting the storage-compartments 310. Similarly to the developing of the partitioning-system, the said compression-system can develop via: (i) a delamination process carried out in the area of at least one side-section 306 and possibly also of a slanted-section 305, by separating the walls of the intermediate component-unit 340 from the walls of the external component-unit 320; and simultaneously, or subsequently (ii) running a progressive repositioning process of the separated walls of the intermediate component-unit 340 during the cycle-of-use a CIC-type receptacle 300, preferably towards the median M following directions A1 and A2 (FIG. 6a).

A compression-system can thus be formed—preferably one operating in both lateral areas of a CIC-type receptacle, e.g. compression-system 341.

Concurrent with the compressing of the storage-compartments 310, the void-spaces 311 should also progressively emerge on the other side of the walls of the compression-system 341. The said void-spaces 311 should thus be formed between the walls of the compression-system 341 and the walls of the external component-unit 320 (FIG. 6b and FIG. 7). The said void-spaces 311 may be filled with atmospheric air just as they develop.

The compression-system 341—in contrast to the rapid configuration of the partitioning-system 361—exhibits a progressive, slow operation, throughout the entire cycle-of-use of a CIC-type receptacle 300. In essence, the action of the compression-system 341 on storage-compartments 310 represents an effect of the internal pressure balancing process inside a CIC-type receptacle 300. At the end of the cycle-of-use of a CIC-type receptacle 300, the fluid-exhaustion of storage-compartments 310 should lead to the actual disappearance of the same; the walls of the compression-system 341 should thus end up being superimposed over those of the partitioning-system 361 (FIG. 6b).

Those said certain lateral areas of the walls of both the internal component-unit 360 and the intermediate component-unit 340 from which derive both the partitioning-system 361 and, respectively, the compression-system 341, will hereafter be also referred to as mobile-sectors.

Both the partitioning-system and the compression-system of a CIC-type receptacle constructed in line with the present invention should preferably consist of at least one mobile-sector.

As already shown, the mobile-sectors develop via a delamination process occurring within the multilayer exterior structure of a CIC-type receptacle and, either simultaneously, or subsequently undergo a repositioning process inside the said CIC-type receptacle. Preferably, both the above-mentioned processes—i.e. delamination and repositioning—should occur in a controlled manner.

In order to facilitate the controlled delamination and repositioning of the mobile-sectors, the multilayer external structure of a CIC-type receptacle should preferably feature:
operational-sections, that is to say sections of the external structure of a CIC-type receptacle (e.g. mid-section 304; slanted-sections 305; side-sections 306; the bottom region of the CIC-type receptacle 300) having a functioning purpose during the operation of said receptacle, including in the pre-cycle-of-use phase;
functional-forms, that is to say particular three-dimensional features/design-characteristics embedded in the external structure of a CIC-type receptacle (e.g. 392, 395, 397 etc. in the case of CIC-type receptacle 300) with a precise functioning purpose;
a connecting-system that could incorporate for example: a permanent-joint (e.g. 382) and a residual interface (e.g. 386, FIG. 6a)—both detailed later;
an adequate degree of adhesion of the interfaces formed between the walls of the component-units (e.g. between 320 and 340, or 340 and 360 of a CIC-type receptacle 300);
an adequate degree of resilience of the structure of the internal component-unit (e.g. 360) and, possibly, of the intermediate component-unit (e.g. 340).

The elements outlined above are detailed in the subsequent parts of the description.

A CIC-type receptacle 300 can have as operational-sections one or more of the following:
mid-section 304—disposed in the proximity of the longitudinal median M and accommodating a connecting-system present between the component-units (i.e. 320, 340 and 360);
side-sections 306—disposed in the lateral areas and producing via delamination the main parts of the mobile-sectors; said side-sections 306 may be the first ones to be delaminated;
slanted-sections 305—disposed between mid-section 304 and side-sections 306 and producing via delamination, if necessary, the peripheral areas of the mobile-sectors; slanted-sections 305 may be delaminated after side-sections 306;
bottom region of the receptacle, meaning the lower region containing the specific horizontal surface of the receptacle on which said receptacle is able to stand; some other operational-sections of a CIC-type receptacle 300 may extend through the bottom region, e.g. mid-section 304, slanted-sections 305 (the bottom region is not illustrated separately).

The operational-sections may be demarcated via (i) certain functional-forms embedded in the external structure of a CIC-type receptacle, but also by means of (ii) general design of the receptacle.

The functional-forms are detailed below.

Since a CIC-type receptacle of the present invention is a multilayer structure, any significant three-dimensional feature present on the surface of the external component-unit—imprinted, embossed etc.—will be also present in the structure of the other component-units. Any such significant three-dimensional feature will be referred to as a functional-form provided it has a precise functioning purpose in operating a CIC-type receptacle.

Functional-forms could for instance demarcate the operational-sections (e.g. 304, 305 and 306) and, consequently, the mobile sectors derived from some of them, and also help control the delamination of said operational-sections and the repositioning of said mobile-sectors.

When delaminating a region of the external structure of a CIC-type receptacle, a functional-form incorporated therein (e.g. 397) becomes separated into at least two corresponding functional-forms, one for each separated layer(s). After delamination, each corresponding functional-form thus obtained may operate independently from the remaining one(s)—that is to say, the one(s) with which it previously formed a multilayered structure and of which it has been separated.

Design-wise, functional-forms could be any geometrical elements and/or patterns having three-dimensional profiles; so functional-forms may be defined in that they:
can have (i) simple, elementary or (ii) complex shape(s)
may interact, meaning that they:
   can be intersected
   can be associated
   can form simple or elaborate patterns
can be inserted in any section and/ or region of a CIC-type receptacle
can be extended/continued from one section and/ or region to another
can be of (i) imprinted-type (engraved) and/ or of (ii) embossed-type (raised)
may have varied three-dimensional profiles:
   the imprints of some may have different depths compared to adjacent ones
   one and the same imprint may record depths of different values from one area to another;
   (similar principles also apply to embossed-type functional-forms).

Operation-wise, functional-forms may be (i) passive and (ii) active, and may facilitate the functioning of a CIC-type receptacle throughout all its operating phases, both before and during the cycle-of-use.

Passive functional-forms are non-responsive elements in the sense that (a.) do not require or (b.) do not make use of the structural resilience or elasticity of the surfaces in which they are incorporated.

Passive functional-forms may be employed for instance (I.) to reinforce the interfaces, thus to strengthen the connection, between the component-units of a CIC-type receptacle, especially in the area of the connecting-system (e.g. circular elements 391 and linear elements 392 and 393, on the surface of the mid-section 304, FIG. 1); and/ or (II.) to act as folding elements, contributing to the controlled plastic deformation of certain surfaces along specific coordinates (e.g. edges 390 and 394, used to demarcate operational-sections 304 and 305 and, correspondingly, 305 and 306, FIG. 1).

Passive functional-forms are also shown in FIG. 8, which illustrates an alternate CIC-type receptacle 420. The oblique walls 425 of the projections 424 fall in the category of embossed-type (raised) functional-forms. In this case, the oblique walls 425 mark a limit between the operational-sections of the alternate CIC-type receptacle 420, constituting an obstacle in delaminating the component-units 423 and 422 by abruptly changing the angle of separation of their walls from the initial multilayer structure. The oblique walls 425 act both as folding elements for the mobile-sectors of a CIC-type receptacle 420 and as reinforcing elements for certain areas of the interfaces present between the component-units of a CIC-type receptacle 420.

When used as folding elements, the passive functional-forms work essentially as embedded hinge-type mechanisms.

The second category of functional-forms is represented by the active ones, which should be mainly present in the delaminating section(s) of a CIC-type receptacle—the section(s) where the mobile-sectors develop from. In the case of a CIC-type receptacle 300, some examples of said active functional-forms are oval elements 397 on side-sections 306, and dot-like element-groups 395 and 396 on slanted-sections 305 (FIG. 1).

The active functional-forms are responsive elements able to react to modifications in their environs. Hence, by making use of their (i) specific geometry and the (ii) resilience of the structure in which they are embedded, the active functional-forms can actively—dynamically—determine a change in (a.) the shape and/or (b.) the path of movement of the related mobile-sectors during an operating phase. For example, but not limited to, the active functional-forms may enact (e.g. oval elements 397) surface flexing on preset coordinates, or may facilitate (e.g. the corrugated-types—not illustrated) either compression or extension, to a certain degree, of the surfaces in which they are embedded etc.. Hence, the active functional-forms fall in the category of embedded mechanisms.

Moreover, subject to their above-indicated (i) specific geometry, and the (degree of) (ii) resilience of the structure in which they are embedded, some active functional-forms may exhibit a non-linear-type behavior, possibly of bi-stable or multi-stable nature. In such case, those particular (a.) non-linear active functional-forms, and/or (b.) the mobile-sectors in which they are embedded (e.g. the mobile-sectors forming the partitioning-system 361) could work as compliant-mechanisms since they: (i) possess structural resilience; (ii) have the ability to transmit in a controlled manner, by means of elastic deformation, movement and energy from one region to another of their own structure; (iii) fulfill specific tasks.

For instance, such compliant-mechanisms could be formed based on geometrical shapes like the oval elements 397 present on the side-sections 306, either as they stand or possibly modified—e.g. part of a more elaborate geometrical pattern etc.. Additionally, mobile-sector-wide compliant-mechanisms could be formed by embedding at least one active functional-form into a structurally resilient mobile-sector, for example at least one of the mobile-sectors the partitioning-system 361 derives from.

Usage-wise, the compliant-mechanisms can prove particularly advantageous for a precise repositioning process and an exact final positioning of the mobile sectors—for example, but not limited to, the wall or walls of the partitioning-system, e.g. partitioning-system 361.

The functional-forms can be incorporated either prior to the blow-molding phase (e.g. vertical grooves 265—FIG. 2, FIG. 3c, FIG. 4a), or during the blow-molding phase (e.g. the oval elements 397) of a CIC-type receptacle 300. Also, certain functional-forms executed during the blow-molding phase can be produced as extensions/additions to some functional-forms already embedded during the injection molding phase of the component-preforms of the preform-set 200.

The functional-forms, the mechanisms, and the processes revealed above are examples only, and are not to be interpreted as limiting in any way the scope of protection claimed by the invention.

The following section details a connecting-system.

A CIC-type receptacle preferably comprises a connecting-system to facilitate the configuration of the partitioning-system, the emergence of the storage-compartments, and the accurate operation of the receptacle during the cycle-of-use.

The connecting-system may be of hybrid-type, consisting of elements with complementary roles, e.g.:
(i) at least one segment of a permanent-joint, of non-breakable nature;
(ii) at least one segment of a residual interface, of non-unbreakable nature.

Certain functional-forms, e.g. reinforcing passive ones, may as well be part of the connecting-system.

The connecting-system preferably has at least two of its parts—e.g. a permanent-joint and a residual interface—superimposed. The components of the connecting-system could be present on the entire height of the receptacle, e.g. in the case of the main embodiment of the invention, or only partly, e.g. in the case of certain alternative embodiments of the invention specified later which require only a partial connecting-system.

The connecting-system should, preferably but not mandatory, be arranged in the median M region of a receptacle. In the case of CIC-type receptacle 300 the general geometry of the connecting-system could coincide with the same of the mid-section 304 (FIG. 1), so it could:
be located in the proximity of the median M of a CIC-type receptacle 300, on the full height and following the longitudinal outline of said receptacle, except for the opening at the top;
have a width that may vary from one region to another (front, rear, bottom region) as well as within the same region of a CIC-type receptacle 300;
have a contour that may be emphasized/accentuated by means of the general design of the CIC-type receptacle 300, and/or via the use of specific functional-forms.

The following paragraphs detail the permanent-joint.

For a CIC-type receptacle 300, the permanent-joint 382 (FIG. 1) is the element providing effective and permanent separation of the storage-compartments 310 and it should preferably be present at least between the intermediate component-unit 340 and the internal component-unit 360, but it may be practiced between all three component-units, as illustrated in FIG. 6a-6b and FIG. 7.

The permanent-joint 382 can be integrated into the structure of a CIC-type receptacle 300 in the manufacturing phase of the preform-set 200, as previously shown.

It is unlikely though that the permanent-joint 382 will be able to preserve its initial position—preferably on the median M—throughout the blow-molding process, and so it could result in having a winding final geometry, as for example illustrated in FIG. 1. For more details, in FIG. 7 are also indicated some alternate positions (482, and 483) that the permanent-joint 382 may end up in.

However, the winding geometry of the permanent-joint 382 could prove irrelevant for the functioning of the connecting-system: in order for the permanent-joint 382 to be effective, its total lateral profile—the width on the lateral axis Y—just needs to remain within the margins of the connecting-system as a whole. In such case, it will be covered, possibly totally masked, by the overlying residual interfaces.

The following paragraphs detail the residual interfaces.

The residual interfaces facilitate the accurate shaping of the connecting-system, storage-compartments, partitioning-system and compression-system. The residual interfaces represent the largest component of the connecting-system in terms of covered area and therefore the general geometry of the residual interfaces may coincide with that of the entire connecting-system. In the case of a CIC-type receptacle 300 the general geometry of the residual interfaces may further coincide with that of the mid-section 304; the residual interfaces may be present either on the entire surface of the mid-section 304, forming a continuous structure, or only in certain regions therein.

As a result of the blow-molding process through which a CIC-type receptacle 300 is obtained, between the walls of the component-units 320 and 340, and 340 and 360, correspondingly, are formed adhesive contact surfaces, interfaces.

The initial interface 380 is formed between the external component-unit 320 and the intermediate component-unit 340 (FIG. 6a); a similar (not illustrated) initial interface is also formed between the intermediate component-unit 340 and the internal component-unit 360.

The configuration of the partitioning-system 361 with the concurrent emergence of storage-compartments 310, and the subsequent operation of a CIC-type receptacle 300, could require: (i) the suppression of the interfaces across some or all parts of the side-sections 306, slanted-sections 305, and, possibly, the bottom region (the bottom region is not illustrated separately); and (ii) the preservation of the interfaces across some or all parts of the mid-section 304.

The interfaces between the intermediate component-unit 340 and the internal component-unit 360 may be suppressed during the liquid-bottling phase; also, they may be suppressed partially or in all necessary areas prior to this phase. The interfaces between the external component-unit 320 and the intermediate component-unit 340 may be suppressed during the cycle-of-use of a CIC-type receptacle 300, or of a system, or device comprising the same; also, they may be suppressed partially or in all necessary areas prior to this phase, either before, or alongside, or after the liquid-bottling.

In the illustrations, the segments 385 (FIG. 6b and FIG. 7) represent fragments of the original interface 380 (FIG. 6a) between the component-units 320 and 340; as a whole, they will be called the residual interface 385. Additionally, the segments 386 (FIG. 6a-6b and FIG. 7) represent fragments of the original interface (not illustrated, as already shown) between the component-units 340 and 360; as a whole, they will be called the residual interface 386.

Each of the residual interfaces 385 and 386 should exert contact between the two corresponding component-units due to their adhesive properties originating from the initial interfaces.

Accordingly, the degree of adhesion of the initial interfaces may be adjusted in several ways, e.g.: the choice of plastics from which the component-units of a CIC-type receptacle 300 are made; the introduction of certain adhesives (or, on the contrary, of separating agents) in those plastics; depositing adhesives (or, on the contrary, separating agents) between the component-preforms of a preform-set 200 (possibly only between certain preforms or only in certain regions between those preforms—for example inside of what later becomes the upper-segment 301 of CIC-type receptacle 300) etc.. The degree of adhesion may thus vary from one interface to another and even within each individual interface, subject to region.

As mentioned, functional-forms (e.g. circular elements 391 and linear elements 392 and 393 on mid-section 304, FIG. 1) could also be used as elements of the connecting-system.

In certain embodiments, a connecting-system may contain elements (or only one element) from just one of the above main categories, namely: (i) residual interfaces and (ii) permanent-joint; but in addition it could include at least one reinforcing functional-form.

The next paragraphs detail using a connecting-system to operate a CIC-type receptacle 300.

Having a winding permanent-joint 382 means that more precise elements are needed to accurately demarcate the partitioning-system 361, but also the compression-system 341, from the structure of the CIC-type receptacle 300, more specifically the contact area between said two systems and the structure of the receptacle.

For the purpose, there can be used edges 390—which form the boundaries between mid-section 304 and slanted-sections 305 on both lateral sides—since these are elements executed precisely. Using edges 390 as delimiting elements on both lateral sides means also that the whole mid-section 304 becomes the boundary, and also the contact area—via the residual interfaces 385 and 386—between both the partitioning-system 361 and the compression-system 341, and the rest of the structure of the receptacle.

For this solution to work effectively, certain segments of the peripheral areas of the mobile sectors—forming both the partitioning-system 361 and compression-system 341—may need to be folded and placed underneath their respective half of mid-section 304 (from an outside to inside viewpoint). Once folded, said segments should be, at least partially, concealed by mid-section 304. For both said systems, those certain segments of the peripheral areas may stem from slanted-sections 305—and even side-sections 306—and the folding could be done by employing the use of passive functional-forms such as edges 390 and 394.

The two main components of the connecting-system—the permanent-joint 382 and the residual interfaces 385 and 386—by being overlaid in the region of the mid-section 304, reciprocally offer one another error margins with regard to the manufacturing and operation.

Thus, the permanent-joint 382 may have a final winding profile as an effect of the blow-molding process, but visually and functionally it should be covered, possibly totally masked, by the residual interfaces 385 and 386, and their host area, mid-section 304.

Conversely, the residual interfaces 385 and 386, by having a non-unbreakable nature, may end-up being unintentionally suppressed, e.g. via a delamination process caused by an accidental deformation of the receptacle. But the separation between the lateral storage-compartments 310 will be preserved at all times as any delamination of the residual interfaces 385 and 386 should ultimately be blocked by the permanent-joint 382, irrespective of its precise location on mid-section 304.

The next paragraphs succinctly identify a number of other constraining factors in the operation of a CIC-type receptacle 300.

In addition to the factors detailed previously, a series of build-class factors intervene as well in the repositioning process, but also with respect to the final position and final shape of the mobile-sectors. The effects of the build-class factors are especially visible in the embodiments of the invention wherein the mobile-sectors forming the walls of a compression-system (e.g. compression-system 341 of a CIC-type receptacle 300) are fashioned as thin membranes with little or no resilience, elasticity, or structural capacity. Some of said build-class factors are listed below:
the overall profile of a CIC-type receptacle; i.e. the shapes and proportions of the vertical segments of a CIC-type receptacle, e.g. 302 and 303 (FIG. 1);
the boundary geometry of the mobile-sectors; said boundary geometry mirrors the boundary geometry of the connecting-system;
the absence of free-moving margins for the mobile-sectors; said mobile-sectors are attached to the structure of the receptacle via the connecting-system.

Helped by the above build-class factors, the membrane-type compression-system walls should still function regularly, akin to a compression-system having a certain degree of structural resilience, especially with regard to their final shape and position. Hence, at the end of the cycle-of-use of a CIC-type receptacle, the membrane-type compression-system walls should end up over those of the partitioning-system (e.g. partitioning-system 361 of a CIC-type receptacle 300) simply because, due to the coercive nature of the above build-class factors, that would represent the sole available final position and, at the same time, the only possible shape they could take.

The following section details other elements related to the production of a CIC-type receptacle.

According to the main embodiment of present invention, the component-units of a CIC-type receptacle 300 should preferably have different structural properties, suited to the functional needs of each component-unit (i.e. 320, 340 and 360).

The walls of the external component-unit 320 may preferably have high enough thickness and strength to ensure the structural strength of the whole assembly. The external component-unit 320 may be made, for example but not exclusively, of PET plastics (polyethylene terephthalate).

The walls of the internal component-unit 360 may preferably have high enough thickness and strength to provide the structural strength required for the partitioning-system 361. The configuration of said partitioning-system 361 should take place on the production/bottling line, so there should be enough energy available for running the delamination and repositioning processes irrespective of the thickness and strength of the material of the internal component-unit 360. The internal component-unit 360 may be hence made, for example but not exclusively, also from PET-type plastics.

The walls of the intermediate component-unit 340 may preferably have less thickness and strength than the others. The repositioning of the walls of the compression-system 341—practically, an effect of the internal pressure balancing within a CIC-type receptacle—occurs during the cycle-of-use, when the amount of available energy may be limited. The intermediate component-unit 340 may be made, for example but not exclusively, from PP-type plastics (polypropylene).

In order to further reinforce a CIC-type receptacle 300, the two walls of the partitioning-system 361 may be bonded together by joint 383 (FIG. 6a-6b and FIG. 7), either partly or on all the height of the receptacle. The joint 383 may be executed for instance with adhesive. Depositing the adhesive on the inner surfaces of the walls of the partitioning-system 361 could precede the partitioning of a CIC-type receptacle 300, or it could be carried out alongside this process; the dimensions, shape and number of elements forming the joint 383 may vary.

During bottling, preferably but not obligatory, the two liquids can be introduced concurrently in a CIC-type receptacle 300. The parameters of the bottling process (liquid velocity, pressure etc.) can be dynamically adjusted throughout the liquid introduction—even separately for each liquid—to facilitate the configuration process (i.e. delamination and repositioning of the mobile-sectors) of the partitioning-system 361.

Over the cycle-of-use, as liquid-consumption from storage-compartments 310 occurs, balancing the internal pressure within a CIC-type receptacle 300 may be achieved by using atmospheric air. The atmospheric air may access the interior of a CIC-type receptacle 300 via the top of said receptacle, through an air-access mechanism whose elements are incorporated in the region of the upper-segment 301. The elements of said air-access mechanism could be typically formed in the manufacturing phase of the component-preforms of the preform-set 200.

The enclosure 226 (FIG. 2 and FIG. 3a) of said air-access mechanism is located between the inner circular wall 224 and outer circular wall 225 present at the top of the external component-preform 220 and consequently also at the top of the external component-unit 320. Upon assembly of the preform-set 200, the flexible circular flap 245 (FIG. 2 and FIG. 3b)—which is attached to the intermediate component-preform 240 (consequently, also to the intermediate component-unit 340)—is inserted in the enclosure 226. Flange 244 (FIG. 2 and FIG. 3b) adjacent to the flexible circular flap 245 closes the enclosure 226 at the top.

The flexible circular flap 245 acts as a check valve: it allows air intake, but not air evacuation from a CIC-type receptacle 300. Atmospheric air enters the enclosure 226 through the dent 227 practiced in the outer circular wall 225 (there may be several such dents). Normally, the free-moving lower edge of the flexible circular flap 245 is in contact with the inner surface of the outer circular wall 225 below the level of the dent 227. When necessary, forced by a pressure differential between the inner and outer surfaces of its body, the flexible circular flap 245 bends, thus allowing air intake.

After passing the flexible circular flap 245, the atmospheric air reaches the space between the external component-unit 320 and the intermediate component-unit 340, via dents 228, thus feeding the two void-spaces 311 (FIG. 6b). The dents 228 present at the top of the inner circular wall 224 could be continued downwardly by means of grooves 232 (FIG. 3a).

The internal pressure within a CIC-type receptacle 300 may be the same at all times in both void-spaces 311 and in both storage-compartments 310: the enclosure 226 should be common to both lateral areas of a CIC-type receptacle 300 and thus it should allow free fluid-communication between the void-spaces 311, through the two dents 228, which leads to pressure-equalization.

Alternatively, the inner circular wall 224 may be omitted in certain configurations; in such case an enclosure 226 may be formed for example between the outer circular wall 225 and the circular wall of the upper-segment 241 of the intermediate component-preform 240 and thus of the corresponding intermediate component-unit 340.

Alternatively, some elements of the air-access mechanism may be produced as separate components, for example: a detached flexible circular flap, an independent closure element that can replace flange 244 etc..

Alternatively, the flange 244 may be omitted completely; in such case the dent 227 may also be omitted.

Fitting the atomizer 500 (FIG. 1) to a CIC-type receptacle 300 can be achieved via the recesses 231 (FIG. 4b) positioned in the area of the upper-segment 301 of a said CIC-type receptacle 300.

The following section discloses alternative CIC-type receptacles, and also alternative components, features and processes related to a CIC-type receptacle besides the alternatives mentioned hitherto.

Alternatively, a CIC-type receptacle made according to present invention may also come in shapes other than those shown in the illustrations related to the description—for example it may be substantially cylindrical, the base may have a petaloid form etc. Such an alternate CIC-type receptacle may still have all or at least part of the components and characteristics of a CIC-type receptacle 300, including a connecting-system, a partitioning-system, a compression-system, operational-sections and functional-forms etc. . . .

Alternatively, the invention also depicts a CIC-type receptacle 430 (FIG. 9)—derived from the main embodiment—which, however, requires the liquid-bottling taking place between the walls of the external component-unit 431 and the walls of the intermediate component-unit 432. The lateral walls of component-units 432 and 433, connected by interface 434, can move unitarily towards the longitudinal median of a CIC-type receptacle 430 hence forming a double-walled partitioning-system wherein each of the walls has a multilayer structure. Two storage-compartments 435 are also formed in the lateral areas of a CIC-type receptacle 430. A connecting-system possibly akin to that of a CIC-type receptacle 300 should preferably be fitted in the mid-section 436 of said receptacle.

In operation, the lateral walls of the intermediate component-unit 432 secede from those of the internal component-unit 433 and move towards the walls of the external component-unit 431. As an alternate solution, the lateral walls of the intermediate component-unit 432 and those of the internal component-unit 433 may be separated before the cycle-of-use phase.

For balancing the internal pressure within a CIC-type receptacle 430, atmospheric air may be introduced between the component-units 432 and 433; in this respect, an air-access mechanism (not illustrated) possibly derived from that of a CIC-type receptacle 300 may be used. If present, such an air-access mechanism should be suitably adapted, e.g. the flexible circular flap and, equally, the flange closing the enclosure containing the flexible circular flap, should be produced separately and inserted only after the liquid-bottling process, so as to allow this process to occur.

Alternatively, the invention also features a CIC-type receptacle 440 (FIG. 10) consisting of four component-units. The liquids are introduced between the two intermediate component-units, 442 and 443. The multilayer partitioning-system consists of the lateral walls of the intermediate component-unit 443 and those of the internal component-unit 444; the storage-compartments 447 are formed in the lateral areas. In operation, the walls of the intermediate component-unit 442 should secede from those of the external component-unit 441 and move towards the partitioning-system; the walls of the intermediate component-unit 443 secede from those of the internal component-unit 444 and move towards the lateral exterior walls of the CIC-type receptacle 440. If present, an air-access mechanism should be suitably adapted.

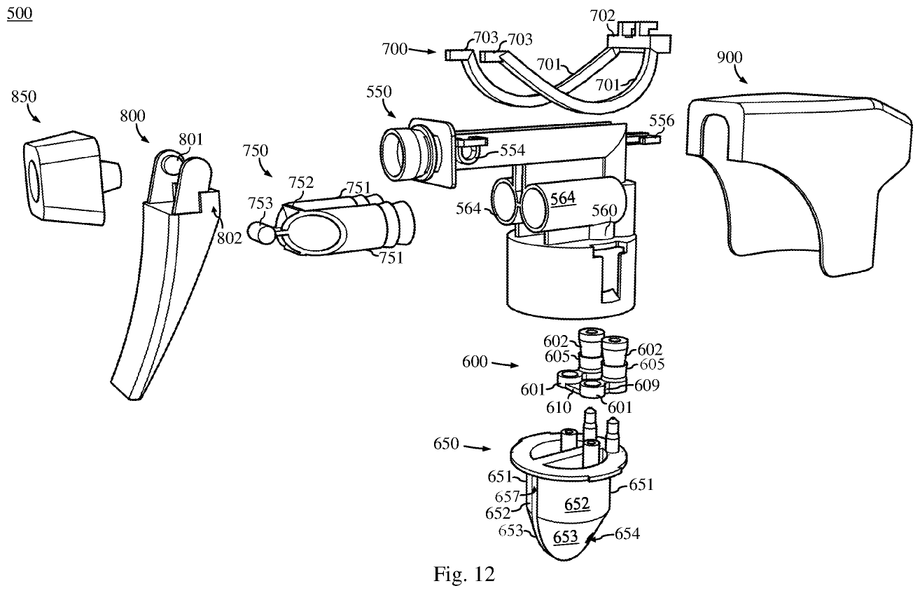

Alternatively, the invention also features a CIC-type receptacle 450 (FIG. 11) consisting of only two component-units, the external component-unit 451 and the internal component-unit 452. The walls of the partitioning-system should be obtained by delaminating and repositioning the lateral walls of the internal component-unit 452 (possibly in a manner similar to the configuration of the internal component-unit 360 of a CIC-type receptacle 300). Quite evidently, the precursor preform-set of a CIC-type receptacle 450 should preferably comprise only two component-preforms. A CIC-type receptacle 450 can have several functional variants.

In a first embodiment, a CIC-type receptacle 450 offers two lateral storage-compartments 454 with fixed geometry—the walls of the partitioning-system are not mobile; the joint 453 may be present between the walls of the partitioning-system to stiffen the assembly.

In another embodiment, the walls of the partitioning-system could be mobile. Thus, said walls of the partitioning-system could also act as a compression-system for the storage-compartments 454. In operation, said walls may return—in step with the consumption of liquids—towards the lateral walls of the external component-unit 451, hence producing a decrease in the volume capacity of the storage-compartments 454; the joint 453 may be omitted if the latter technical solution is adopted.

Alternatively, it may also be provided a CIC-type receptacle (not illustrated)—derived from a CIC-type receptacle 450 (FIG. 11)—which may have a single inner storage-compartment formed between the walls of the external and internal component-units; in this case, a connecting-system between those two component-units of such a CIC-type receptacle should be at least in part omitted, thus facilitating free fluid-communication between the lateral storage areas within the receptacle. So, provided it is present at all, a connecting-system may not extend on the entire height of the receptacle.

Alternatively, it may also be provided a CIC-type receptacle (not illustrated) which may partially be similar to conventional CIC-type receptacles. The said CIC-type receptacle made according to the present invention may therefore boast two component-units and a single storage-compartment created inside its internal component-unit. In contrast to conventional ones, such a CIC-type receptacle formed in accordance with the present invention should be able to incorporate in its external multilayer structure and also make use of: (i) at least one operational-section and/or (ii) at least one functional-form, possibly of compliant-mechanism-type (elements described previously in relation to CIC-type receptacle 300). Furthermore, such a CIC-type receptacle formed in accordance with the present invention may also incorporate, at least in certain embodiments, a connecting-system between its component-units. The said connecting-system may be similar to that of a CIC-type receptacle 300, it may consist of at least one permanent-joint and/or one residual interface and, additionally, said connecting-system may also be reinforced with dedicated functional-forms.

Alternatively, it may also be provided a CIC-type receptacle (not illustrated) with more than two storage-compartments. Such alternative CIC-type receptacle could be made as well out of three component-units—similar to a CIC-type receptacle 300—but, due to different partitioning, it may have more than two storage-compartments: for example, a storage-compartment may be created between the walls of the partitioning-system. A CIC-type receptacle with more than two storage-compartments may also be obtained from a number of component-units other than three. For example, it could be similar to a CIC-type receptacle 440, but with supplementary storage-compartments between the walls of the partitioning-system.

Alternatively—for any of the multi-chamber constructive variants—the storage-compartments may have different volume sizes and/or may be asymmetrical (variants not illustrated).

Alternatively, the partitioning-system of a CIC-type receptacle can be positioned on coordinates other than those presented in the main embodiment of the invention. For example, the partitioning-system may intersect the longitudinal median of a CIC-type receptacle. Quite evidently, such a connecting-system will also have to assume a changed position, most likely on coordinates different than the median M.

Alternatively, it may also be provided a CIC-type receptacle similar to a CIC-type receptacle 300 in that it may comprise three component-units, but in contrast it may have storage-compartments communicating with each other. Such a receptacle may hence be susceptible to store a single type of fluid. The connecting-system between the component-units of such a receptacle may be a partial one. Quite evidently, a connecting-system of this kind may not extend on the entire height of the receptacle. Also quite evidently, the permanent-joint made within a preform-set from which derives a receptacle having a partial connecting-system—provided the connecting-system includes a permanent-joint at all—may extend only partly on the height of said preform-set. Just as an example, it can possibly be produced only as a substantially vertical limited-length segment.

Alternatively, balancing the internal pressure over the cycle-of-use of a CIC-type receptacle may also be achieved by introducing a pressurized fluid inside dedicated areas of said receptacle (dedicated areas similar to void-spaces 311 of a CIC-type receptacle 300), a solution in particular applicable to a CIC-type receptacle packing pressurized liquids (carbonated beverages etc. . . . ).

Alternatively, various components, processes and features associated with CIC-type receptacles shown above may be combined to obtain variants of such CIC-type receptacles; the invention does not insist on them additionally, many combinations being evident.

The following paragraphs provide at least one configuration method for obtaining both a partitioning-system and storage-compartments within a CIC-type receptacle 300.

In the first stage it is provided a previously detailed CIC-type receptacle 300 in the state it is in at the end of the blow-molding process (FIG. 4a).

In the second stage it is performed a preconfiguring process of the storage-compartments 310. The preconfiguring process takes place at the level of the upper-segment 301 of a CIC-type receptacle 300, by repositioning at least one lateral region, namely a petaloid protrusion 264 (FIG. 4a)—present in the lateral regions of the top end of the internal component-unit 360—towards the median M. The relocation may be performed via mechanical means; grooves 265 are functional-forms acting as folding elements thus facilitating the relocation of petaloid protrusions 264. At the end of this stage, incipient storage-compartments 310 (FIG. 4b) should be formed at the level of the upper-segment 301. At this point, below the level of the upper-segment 301, the walls of the component-units 360 and 340 should still be united.

In the third stage a two-phase complete configuration—first a delamination, and then a relocation—it is performed with regard to the partitioning-system 361 and, concurrently, the storage-compartments 310. This process is preferably, but not mandatory, performed at the same time with the liquid-bottling process. The liquid-bottling takes place via the incipient storage-compartments 310 obtained in the previous stage. By shooting at least one pressurized liquid in said incipient storage-compartments 310, a delamination process—the first phase—should occur below the level of the upper-segment 301. More precisely, at least in the area of one of the side-sections 306 it should occur the suppression of the interface present between the walls of the internal component-unit 360 and those of the intermediate component-unit 340. At least one mobile-sector should thus develop. In the second phase, under the pressure exerted by at least one liquid, the at least one mobile-sector is repositioned preferably towards the region of the median M.

When the repositioning of the lateral walls of the internal component-unit 360 ends, a double-walled partitioning-system 361 (FIG. 6a) should be formed in the region of the median M of the CIC-type receptacle 300. Concurrently, two complete, and fully bottled, storage-compartments 310 should emerge between the walls of the partitioning-system 361 and the outer walls of a CIC-type receptacle 300 on the lateral sides of the same.

The delamination and repositioning of said walls of the internal component-unit 360 may be actively influenced by the presence in the structure of a CIC-type receptacle 300 of certain elements detailed previously, among which: operational-sections (e.g. 304, 305, 306), functional-forms (e.g. 394, 395, 396, 397), one or more components of a connecting-system as detailed previously, and the build-class factors.

Alternatively, a configuration method for a CIC-type receptacle may involve obtaining at least one incipient storage-compartment by enlarging at least one initial cavity. Accordingly, an alternate CIC-type receptacle 410 (FIG. 5) may have lateral notches 414 at the top end of the internal component-unit 413. The cavities 415 should be formed between the walls of the notches 414 and the walls of the intermediate component-unit 412, as early as the assembly stage of the preform-set from which the said receptacle 410 derives. By repositioning at least one of the notches 414, either via mechanical means or by using a fluid, e.g. compressed air, the respective cavity 415 should be enlarged and thus at least one incipient storage-compartment should be formed.

Alternatively, a configuration method for a CIC-type receptacle (not illustrated) can combine the two previous solutions.

Alternatively, a configuration method for a CIC-type receptacle may involve utilizing a CIC-type receptacle (not illustrated) which has no protrusions and/or notches. Still, at least one incipient storage-compartment may be formed by using appropriate means—especially, but not exclusively, mechanical-type means—to push at least one lateral region present at the top end of one of the internal component-units towards the region of the median M.

Alternatively, a configuration method for a CIC-type receptacle 300 may involve that the third stage, the complete configuration, takes place prior to and not simultaneously with the liquid-bottling, in a two phase process—first a delamination, and then a repositioning. This configuration prior to the liquid-bottling may also be only a partial one. To perform the two stages of the configuration, either a fluid, or mechanical means, or possibly a combination of methods may be used. In the case of using a fluid, in at least one incipient storage-compartment 310 may be introduced, for example but not exclusively, compressed air. The first phase is the delamination. Subjected to compressed air, the interface present between of the walls of the internal component-unit 360 and intermediate component-unit 340 should be suppressed at least in one lateral area. At least one mobile-sector should thus develop. In the second phase, under the pressure exerted by the compressed air, the at least one mobile-sector should be repositioned preferably towards the region of the median M, thus achieving both the partitioning-system 361 and storage-compartments 310. In the case of using mechanical means, certain mechanical parts, e.g. rod-type ones, may be introduced through at least one incipient storage-compartment 310 to suppress the interface between the internal component-unit 360 and intermediate component-unit 340. The mechanical parts then can be moved towards the median M with the purpose of pushing against at least one lateral wall of the internal component-unit 360, hence repositioning and transforming said at least one wall into a partitioning-system 361. As already mentioned, a combination of methods can also be employed, for example involving both mechanical means and a fluid. The said configuration of the storage-compartments 310 prior to liquid-bottling may potentially be carried out in continuation of the blow-molding process, while the CIC-type receptacle 300 still is, at least partially, in the mold in which said process was conducted.

Other configuration methods involve combining elements of the above-indicated methods.

### Atomizer Details

Next, the description details an atomizer 500 compatible with a CIC-type receptacle 300. The atomizer 500 operates on principles similar to those of conventional hand-operated atomizers.

FIG. 12 illustrates the atomizer 500 which is composed of:
a main body 550, having at least one cylinder
a valve-system 600, comprising at least one valve-subassembly
a return-spring 700
a piston-set 750, comprising at least one piston
an actuation element 800, preferably of trigger type
a spraying nozzle 850
a protection element 900

A closing assembly 650 which ensures the closure of the storage-compartments of a compatible receptacle is also attached to the atomizer.

Among the elements of the main body 550 there are:
cylinders 564, which constitute the pressure lifting chambers
housings 560 and valve-housings 561 (FIG. 14-15), which accommodate the main components of the valve-system
perforations 563 (FIG. 15), which connect the valve-housings 561 and the cylinders 564
semicylindrical ducts 570 and 571, which are part of the liquid-passageways
forepart region of the main body 550, which forms together with the spraying nozzle 850 the liquid spraying assembly.

The valve-system 600 (FIG. 12 and FIG. 15) consists preferably of two valve-subassemblies. Each valve-subassembly consists mainly of a valve 602 (FIG. 12) and an annular seal 601; a bridge 609 connects the annular seal 601 and the valve 602. Each valve-subassembly of a valve-system 600 is connected to any similar one by a bridge 610.

Upon assembly, the valves 602 are inserted into the valve-housings 561 of the main body 550. Each of the valves 602 is composed of a:
sealing base 606—which seals the opening at the bottom of the corresponding valve-housing 561;
flexible circular flap 605—acting as a check-valve;
semiflexible crown 603—acting as a precompression mechanism and which said semiflexible crown 603 includes:
   the circular region 604 acting as a non-permanent sealing element against the internal surface of the walls of the corresponding valve-housing 561,
   a horizontal wall 608 (FIG. 15)—which blocks in operation the vertical (downwardly) circulation of liquid through the body of the valve 602; it also exerts control over the degree of flexibility of the semiflexible crown 603, hence also on the precompression.

The arrangement of the regions 607 (FIG. 15) of the valves 602 dictates—within the main body 550—the exact location of the perforations 563 which connect the valve-housings 561 and the cylinders 564. Positioning the perforations 563 between the upper edge of the flexible circular flaps 605 and the lower edge of the circular regions 604 enables proper operation of the atomizer.

Upon assembly, the annular seals 601 are inserted into the housings 560 (FIG. 14 and FIG. 15). Annular seals 601 serve to seal the openings at the bottom of said housings 560.

Upon assembly, the bridges 609 are inserted into the lower sections of the connecting passages 562 present between the housings 560 and valve-housings 561. The bridges 609 are sealing elements blocking said lower sections of the connecting passages 562. The upper sections of said connecting passages 562 remain open even after the bridges 609 are fitted in place, forming between each housing 560 and the corresponding valve-housing 561 a channel allowing free fluid-communication.

The bridge 610 reaches in the recess 566 (FIG. 14).

The following paragraphs succinctly disclose the functioning stages of an atomizer 500.

The liquids are extracted from the storage-compartments 310 of a CIC-type receptacle 300 and transferred inside the housings 560 of the main body 550 via the tubes 655 (FIG. 15). The said tubes 655 are part of the closing assembly 650 (the closing assembly will be detailed later). The top end of each tube 655 penetrates the corresponding annular seal 601 present at the bottom of its respective housing 560.

The liquids then reach the valve-housings 561 via the upper sections of the connecting passages 562, basically flowing above the bridges 609. Next, flexible circular flaps 605 allow liquids to access perforations 563 and subsequently cylinders 564.

While operating the atomizer, as the pressure increases, liquids are being discharged from the cylinders 564 into the valve-housings 561 also by means of perforations 563. The flexible circular flaps 605 prevent the liquids flowing back to housings 560. The increasing pressure in the valve-housings 561 leads to the partial squashing of the semiflexible crowns 603 of the valves 602; consequently, the circular regions 604 of the semiflexible crowns 603 partially lose contact with the internal surface of the valve-housings 561; the liquids are thus forced to the top end of the valve-housings 561. Subsequently, the liquids are transferred through apertures 565 (FIG. 14) in the semicylindrical ducts 570 and 571 (FIG. 14 and FIG. 15). The liquids then progress to the front of the main body 550, reaching the spraying assembly.

The following paragraphs detail the spraying assembly, formed by the forepart region of the main body 550 and the spraying nozzle 850.

FIG. 16 shows the forepart region of the main body 550 and the spraying nozzle 850, adjacently, with a view of their interior. FIG. 17 and FIG. 18 show the same two components, illustrated at the same angle as in FIG. 16, but from the opposite direction. FIG. 17 provides a view of the front region of the spraying nozzle 850; FIG. 18 illustrates the forepart region of the main body 550, in a cross sectional perspective from the rear towards the front end.

A cylindrical region 580 present in the forepart region of the main body 550 (FIG. 14) is continued towards the back end with a frustoconical region 590 (FIG. 14-15). The large base of the frustoconical region 590 is open, in continuation of the cylindrical region 580, and the small base is closed. Horizontal semicylindrical ducts 571 intersect the frustoconical region 590 (FIG. 14 and FIG. 15); the inner-passageways 573 (FIG. 18) of said horizontal semicylindrical ducts 571 open up inside the frustoconical region 590 in the form of apertures 592 (FIG. 16) practiced on the inner face 591.

The cylindrical rod member 593 (FIG. 16) is arranged at the center of the closed small base of the frustoconical region 590 and has two longitudinal grooves 594, as well as a swirling chamber 595 at the front.

The spraying nozzle 850 has some corresponding elements to those present in the forepart region of the main body 550. Upon assembly, the corresponding elements of the two components of the spraying assembly come into contact: the outer face 852 of the frustoconical region 851 of the spraying nozzle 850 comes into contact with the inner face 591 of the frustoconical region 590; the cylindrical rod member 593 reaches inside the cylindrical conduit 853 of the spraying nozzle 850.

The spraying nozzle 850 can rotate around the cylindrical rod member 593, having two positions: closed, when liquid spraying is blocked, and open, when spraying is possible. In the closed position, the outer face 852 of the frustoconical region 851 of the spraying nozzle 850 obstructs the apertures 592. The slots 854 are communication passages and, in closed position, are spaced out relative to the longitudinal grooves 594, preferably at an angle of 90 degrees. By rotating the spraying nozzle 850 by 90 degrees, in open position, slots 854 allow communication between apertures 592 and longitudinal grooves 594. The liquids then reach the swirling chamber 595, where they are mixed, and subsequently the liquid mixture is discharged from the atomizer 500 via the orifice 857 (FIG. 17).

The following paragraphs detail additional components and features relating to the atomizer 500.

Attaching the atomizer 500 to a CIC-type receptacle 300 is carried out by means of the socket 551 of the main body 550; the projections 553 in the area of the cutouts 552 (FIG. 14-15)—projections oriented towards the interior of the socket—slot into the recesses 231 (FIG. 4b) of the upper-segment 301 of a CIC-type receptacle 300.

Inside the main body 550, the liquid-passageway of each one of the two liquids dispersed by the atomizer 500 can be executed—during the injection molding phase of said main body 550—such as to result unitary and continuous. The inner-passageways of the vertical semicylindrical ducts 570 can be practiced using the apertures 565 (FIG. 14), and those of the horizontal semicylindrical ducts 571 using the apertures 592 (FIG. 16). The inner-passageways of the two semicylindrical ducts 570 and 571 may form an angle of 90 degrees and may unite in the region 572 of the main body 550 (FIG. 15).

In order to reinforce the main body 550, the horizontal semicylindrical ducts 571 may be joined via deck 555 (FIG. 14 and FIG. 15), which said deck 555 may be continued at the rear by console 556, which said console 556 in turn may serve as mounting base for the return-spring 700.

The return-spring 700 (FIG. 12) may be made of acetal/polyacetal or other types of plastics; the two curved arms 701 store—and subsequently release—an amount of the energy introduced into the system when operating the dispensing system 100 and therefore the atomizer 500. The return-spring 700 is secured to the main body 550 via the fixing base 702; the curved arms 701 sit alongside the flanks of the cylinders 564, on the lateral sides of the main body of the atomizer (FIG. 13); fitting-ends 703 come in contact with the actuation element 800 in the upper lateral areas 802 of the latter.

The actuation element 800 (FIG. 12) may be attached to the seats 554 of the main body 550 via pins 801 located at its upper extremity.

The piston-set 750 (FIG. 12) consists preferably of two pistons 751 joined by bridge 752. Upon assembly, each of the pistons is inserted in the corresponding cylinder 564 of the main body 550. When triggering the actuation element 800, the piston-set 750 is moved via projection 753.

The closing assembly 650 (FIG. 12 and FIG. 15) acts as an intermediate component between the atomizer 500 and CIC-type receptacle 300. The closing assembly 650 ensures the closure of the storage-compartments 310 of a CIC-type receptacle 300 and, equally, mediates the transfer of liquids from a CIC-type receptacle 300 into an atomizer 500. The closing assembly 650 mainly comprises: two stopping members 651; two tubes 655 (already mentioned); two fastening rods 656; flange 658.

Upon assembly, each of the stopping members 651 is inserted in the corresponding storage-compartment 310 of a CIC-type receptacle 300. Within the closing assembly 650, the gap 657 separates the two stopping members 651; the gap 657 is the place where the upper extremities of the walls of the partitioning-system 361 of a CIC-type receptacle 300 will be positioned upon assembly.

Each of the stopping members 651 consists of a semicylindrical section 652 which is continued downwardly by a petaloid section 653. Upon assembly, the semicylindrical sections 652 obstruct the storage-compartments 310 in the region of the upper-segment 301 of a CIC-type receptacle 300 (FIG. 4b). The petaloid sections 653 preferably come to be positioned below the level of the upper-segment 301, thus providing sitting surfaces for the top parts of the walls of the compression-system 341. In the absence of petaloid sections 653, towards the end of the cycle-of-use of a CIC-type receptacle 300 pockets of non-dispersible liquid may develop in those areas at the top end of the storage-compartments 310, below the upper-segments 301.

The tubes 655 allow liquid-extraction from the storage-compartments 310. The tubes 655 are connected to the bodies of the stopping members 651, more specifically to the petaloid sections 653. The perforations 654 present at the bottom of said tubes 655 penetrate the surface of the petaloid sections 653 (FIG. 13 and FIG. 15). The top ends of the tubes 655 may be projected above the level of the flange 658.

Upon assembly, the fastening rods 656 reach the inner recesses of valves 602, thus additionally securing the valve-system 600.

The flange 658 acts as a connecting bridge for stopping members 651 and as a base for fastening rods 656. The projections 659 (FIG. 13 and FIG. 15) of the flange 658 help to secure the closing assembly 650 to the structure of the main body 550 of the atomizer 500. Upon assembly, the projections 659 reach the upper regions of the cutouts 552 present in the lateral areas of the socket 551 (FIG. 15).

Alternatively, an atomizer may be fitted with dip tubes to facilitate liquid-extraction from the storage-compartments of a CIC-type receptacle. The atomizer can be fitted with such dip tubes for one or more storage-compartments. In the case of atomizer 500, dip tubes may be connected to stopping members 651 by means of perforations 654; the length of said dip tubes may vary.

Alternatively, an atomizer (not illustrated) capable of dispersing liquids from a CIC-type receptacle with compartments with uneven volumes may have cylinders of different sizes; the corresponding pistons may also have different sizes.

By combining a CIC-type receptacle analogous to a CIC-type receptacle 300, or one of the alternatives, with an atomizer analogous to an atomizer 500, or one of the alternatives, and also with a closing assembly analogous to a closing assembly 650, a fully functional dispensing system—possibly of multifluid type—is obtained.

1. Receptacle of container in container type, comprising one external component-unit and at least one internal component-unit, obtained from a preform-set through a blow-molding process, characterized in that:
(I) a hybrid connecting-system is provided therein between at least two of the component-units in order to first help convert said receptacle into a multi-chamber one, and then operate the resulting said multi-chamber receptacle,
wherein said hybrid connecting-system consists of at least two different elements with complementary roles:
i) at least one segment of a permanent-joint of non-breakable nature, in the shape of at least one line or stripe of adhesive and/or weld type
wherein said permanent-joint is integrated into the structure of said receptacle in the manufacturing phase of the preform-set which said receptacle derives from
wherein at the end of the blow-molding process said permanent-joint is unable to fully reach its intended position i.e. preferably on the longitudinal median of said receptacle
and consequently, wherein said permanent-joint ends up having a non-orderly, most likely winding shape thus rendering necessary the use of a second connecting element so as to give the connecting-system a definite, predictable geometry
ii) at least one segment of a residual interface of non-unbreakable nature, therefore a connecting element susceptible to loosening under certain circumstances,
wherein said residual interface represents a remainder of the original interface between any two component-units of said receptacle, hence consisting of at least an area of non-unbreakable adhesive contact between said component-units
wherein said residual interface represents the largest component of said hybrid connecting-system in terms of covered area and therefore the general geometry of the entire said hybrid connecting-system coincides with that of said residual interface
wherein said residual interface is contained within a dedicated operational-section of said receptacle
wherein said operational-section represents a clearly demarcated area on the external structure of said receptacle by means of general design and/or supplementary design features of said receptacle
wherein said operational-section is positioned preferably in the proximity of, and also preferably superimposed on, the longitudinal median of said receptacle
wherein the precise geometric characteristics of said operational-section provide accurate shaping for said residual interface and, consequently, for the entire said hybrid connecting-system
and wherein the components of said hybrid connecting-system are superimposed and thus reciprocally offer one another error margins with regard to manufacturing and operation, as follows:
said residual interface, by virtue of its much larger size and precise geometry, covers physically and counterbalances functionally the winding, non-orderly final shape of said permanent-joint
said permanent-joint acts as a safety feature preventing the free communication between the storage-compartments of said multi-chamber receptacle in case an unintended partial delamination process affecting said residual-interface takes place e.g. following an accidental deformation of said receptacle
and wherein said hybrid connecting-system extends preferably on the entire height but at least on one part of the height of said receptacle;
receptacle also characterized in that:
(II) a partitioning-system is provided therein so as to convert a single volume receptacle of container in container type into a multi-chamber one
wherein said partitioning-system is obtained by means of morphing an at least one internal component-unit into an internal divider between at least two storage-compartments
wherein said partitioning-system consists therefore of at least one mobile-sector which represents a surface that:
i) develops from said at least one internal component-unit via a delamination process taking place between any two component-units of said receptacle
and, either simultaneously, or subsequently, also
ii) undergoes a repositioning process
and wherein said delamination and repositioning processes occur:
either prior to, or in the liquid-bottling stage of said receptacle, or over both of the previously indicated phases; and
in a way that employs the use either of at least one fluid, or of mechanical means, or of a combination of the two;
and wherein said partitioning-system has its margins connected to the structure of said receptacle either (a.) partially, or (b.) completely, by means of the previously indicated hybrid connecting-system.

2. Receptacle of claim 1, wherein a compression-system is provided so as to produce a decrease in the volume capacity of at least one storage-compartment therein during the cycle-of-use of said receptacle in step with liquid-utilization therefrom,
wherein said compression-system consists of at least one mobile-sector which represents a surface that:
i) develops from said at least one internal component-unit via a delamination process taking place between any two component-units of said receptacle
and, either simultaneously, or subsequently, also
ii) undergoes a repositioning process;
and wherein said delamination process occurs:
either prior to, or over the cycle-of-use of the receptacle; and
in a way that employs the use either of at least one fluid, or of mechanical means, or of a combination of the two;
and wherein said repositioning process preferably occurs:
during the cycle-of-use of the receptacle; and
in a way that employs the use of at least one fluid of which pressure-level can be either similar to, or different from that of the surrounding environment of said receptacle;
and wherein said compression-system has its margins connected to the structure of said receptacle either (a.) partially, or (b.) completely, by means of said hybrid connecting-system.

3. Receptacle of claim 2, wherein said partitioning-system and said compression-system share an at least one mobile-sector.

4. Receptacle of claim 1, having at least one functional-form, wherein a said functional-form represents any three-dimensional feature embedded anywhere therein with any precise functioning purpose, such as:
i. to strengthen the connection between at least two of the component-units of the receptacle
ii. to help demarcate at least one operational-section on the structure of said receptacle
iii. to influence the shape and/or path of movement of a mobile-sector in the course of a repositioning process of the same.

5. Receptacle of claim 1, wherein at least one of:
i. a mobile-sector
ii. a functional-form embedded within a mobile-sector,
by making use of the resilience of the material of which the corresponding at least one internal component-unit is produced, exhibits at least partially a non-linear type behavior in the course of a repositioning process.

6. Preform-set for producing a receptacle of container in container type of claim 1, comprising one external component-preform and at least one internal component-preform,
wherein at least one permanent-joint of adhesive or weld type is provided between at least two of the component-preforms in the form of at least one non-breakable line or stripe executed as at least one preferably substantially vertical segment, extending preferably on the entire height, but at least on one part of the height of the preform-set, and positioned preferably, but not mandatory, on the longitudinal median,
wherein the longitudinal median preferably matches the same of the resulting receptacle;
and wherein said preform-set equally comprises:
i. at least one coupling element situated on the upper-segment of the external component-preform so as to enable the fitting to the resulting receptacle of a closing element such as, e.g., a dispensing head or atomizer;
ii. a multicomponent pressure-equalization air-access mechanism, incorporated in the neck area,
wherein said pressure-equalization air-access mechanism helps balance at any given moment the pressure level inside the resulting multi-chamber receptacle, not only with respect to the outside, atmospheric pressure, but also between its internal compartments,
wherein said pressure-equalization air-access mechanism comprises inter alia:
a) a built-in enclosure formed either: (1.) between two preferably concentric circular walls located in the upper-segment of the external component-preform; or (2.) between a preferably circular wall located in the upper-segment of the external component-preform and a preferably circular wall located in the upper-segment of an at least one internal component-preform;
b) a flexible circular flap acting as a check-valve, wherein upon assembling the flexible circular flap is inserted into said built-in enclosure, and wherein said flexible circular flap is either: (1.) attached to the upper-segment of an at least one internal component-preform; or (2.) is produced and fitted separately.

7. Method for partitioning a receptacle of container in container type, with the specific purpose of converting a standard, single volume, receptacle of container in container type into a multi-chamber one, in order to have the option of storing more than one fluid inside,
wherein the process involves morphing an internal component-unit of said receptacle into a partitioning-system, prior to the bottling process, as follows:
i) in the first-stage, a receptacle of container in container type is provided in the state is in at the end of the blow-molding process;
ii) in the second-stage, a preconfiguring process is carried out in the upper-segment area of the receptacle, in order to create at least one incipient storage-compartment in the area of the neck of the receptacle, by repositioning at least one lateral region present at the top end of an at least one internal component-unit, using either mechanical means, or at least one fluid, or a combination of the two;
iii) in the third-stage, a two-phase complete configuring process is carried out as follows:
a) initially, by at least partially delaminating the external structure of the receptacle, starting the process within the previously indicated at least one incipient storage-compartment created in the preconfiguring stage in the area of the neck of the receptacle; and
b) next, by repositioning, preferably towards the longitudinal median of the receptacle, at least one mobile-sector which develops from the structure of an at least one internal component-unit via the previously indicated delamination, and which said at least one mobile-sector starts dividing the internal volume of said receptacle at the time its repositioning starts;
and wherein said two phases of the third-stage, the delaminating and, respectively, the repositioning, are carried out:
1. either independently, or concurrently; and
2. by employing either mechanical means, or at least one fluid, or a combination of the two;
and wherein at the end of the partitioning process is obtained a partitioning-system which converts a standard, single volume receptacle of container in container type into a multi-chamber one, ready to store separately at least two fluids at once.

8. Method of claim 7, wherein: (i.) preferably the whole third-stage, (ii.) but at least the second phase of the third-stage, namely the repositioning, is at least partially carried out during the liquid-bottling stage of the receptacle, utilizing at least one liquid that is actually being bottled, and thus finalizing the steps of the partitioning process concomitantly with the completion of the bottling process.

9. Atomizer for a multi-chamber receptacle of container in container type, able to disperse two liquids at the same time, comprising at least:
i. a main body, having at least one cylinder;
ii. a piston-set, comprising at least one piston;
iii. an actuation element, preferably of trigger type;
iv. a spraying nozzle;
wherein the forepart region of the main body comprises a cylindrical region continued towards the back-end by a frustoconical region, wherein the large base of the frustoconical region is open, in continuation of the said cylindrical region, and the small base is closed;
and wherein said frustoconical region is intersected by at least one duct, wherein the inner-passageway of said at least one duct opens up inside the frustoconical region in the form of an aperture.

10. Atomizer of claim 9, comprising at least one of:
i. a plastic return-spring having two curved arms which upon assembling sit on the lateral sides of the main body of the atomizer, wherein said plastic return-spring is secured via a fastening base to a console present at the rear end of the main body of the atomizer;
ii. a precompression valve-system comprising at least one valve-subassembly which consists at least of: (a.) a valve; (b.) an annular seal; (c.) a bridge, which connects the valve and the annular seal;
wherein said valve consists at least of: (1.) a valve body; (2.) a sealing base; (3.) a flexible circular flap acting as a check-valve; (4.) a semiflexible crown functioning as a precompression mechanism;
and wherein said semiflexible crown:
consists of a circular region at the top of the valve body operating as a nonpermanent sealing element against the walls of the corresponding valve housing;
includes an inner horizontal wall that blocks the liquid circulation through the body of the valve and exerts control over the degree of flexibility of the semiflexible crown, hence also exerts control on the precompression;
wherein said at least one valve-subassembly is connected to any similar one by a bridge.
